(19) United States
(12) Patent Application Publication
(10) Pub. No.: US 2022/0261751 A1
(43) Pub. Date: Aug. 18, 2022

(54) MANAGEMENT SYSTEM, MANAGEMENT METHOD, AND MANAGEMENT PROGRAM

(71) Applicant: TOYOTA JIDOSHA KABUSHIKI KAISHA, Toyota-shi (JP)

(72) Inventors: Hirotaka KOMURA, Tokyo (JP); Kunihiro IWAMOTO, Nagakute-shi (JP); Yuta ITOZAWA, Nagoya-shi (JP); Yutaro TAKAGI, Tokyo (JP); Yoshiaki NAKAMOTO, Nisshin-shi (JP); Junya OTA, Tokyo (JP)

(21) Appl. No.: 17/651,266

(22) Filed: Feb. 16, 2022

(30) Foreign Application Priority Data
Feb. 18, 2021 (JP) 2021-023919

(51) Int. Cl. G06Q 10/08

(52) U.S. Cl. CPC G06Q 10/0833; G06Q 10/087

(57) ABSTRACT

A management system manages the placement of an order for consumed goods based on a delivery period. The management system includes a prediction unit configured to predict a consumption completion period, which is a period from the start to the completion of consumption of a predetermined quantity of goods, based on a consumption history of the goods and a determination unit configured to determine whether the delivery period needs to be changed based on the prediction result.

### CROSS-REFERENCE TO RELATED APPLICATION

This application claims priority to Japanese Patent Application No. 2021-023919 filed on Feb. 18, 2021, incorporated herein by reference in its entirety.

### BACKGROUND

### 1. Technical Field

The present disclosure relates to a management system, a management method, and a management program.

### 2. Description of Related Art

Japanese Unexamined Patent Application Publication No. 2003-150868 (JP 2003-150868 A) discloses a system for regularly delivering goods at a delivery unit and at a delivery interval specified by a consumer. According to the technique described in JP 2003-150868 A, the consumer can change the delivery interval as appropriate.

### SUMMARY

According to the technique described in JP 2003-150868 A, there is a problem that a shortage occurs when the delivery interval of goods is longer than the consumption pace of goods. Furthermore, according to the technique described in JP 2003-150868 A, there is a problem that the stock quantity becomes excessive when the delivery interval of goods is shorter than the consumption pace of goods.

The present disclosure provides a management system, a management method, and a management program that make it possible to deliver goods in an appropriate delivery period.

A first aspect of the embodiment relates to a management system that places an order for consumed goods based on a delivery period. The management system includes a prediction unit and a determination unit. The prediction unit is configured to predict a consumption completion period based on the consumption history of the goods. The consumption completion period is a period from the start to the completion of consumption of a predetermined quantity of the goods. The determination unit is configured to determine whether the delivery period needs to be changed based on the prediction result predicted by the prediction unit.

A second aspect of the embodiment relates to a management method for managing the placement of an order for consumed goods based on a delivery period. The management method is performed by a computer. The management method includes predicting a consumption completion period based on the consumption history of the goods and determining whether the delivery period needs to be changed based on a prediction result predicted by the predicting. The consumption completion period is a period from the start to the completion of consumption of a predetermined quantity of the goods.

A third aspect of the embodiment relates to a management program that manages the placement of an order for consumed goods based on a delivery period. The management program causes a computer to perform predicting a consumption completion period based on the consumption history of the goods and determining whether the delivery period needs to be changed based on a prediction result predicted by the predicting. The consumption completion period is a period from the start to the completion of consumption of a predetermined quantity of the goods.

The present disclosure makes it possible to provide a management system, a management method, and a management program for delivering goods in an appropriate delivery period.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a block diagram showing a system configuration of a management system according to an embodiment;

FIG. 2 is a block diagram showing a configuration of a management server according to the embodiment; and

FIG. 3 is a flowchart showing a flow of a management method according to embodiment.

### DETAILED DESCRIPTION OF EMBODIMENTS

It should be noted that, though the present disclosure will be described below using an embodiment of the present disclosure, the present disclosure described in claims is not limited to the embodiment below. It should also be noted that not all of the components described in the embodiment are indispensable as means for solving the problem.

### First Embodiment

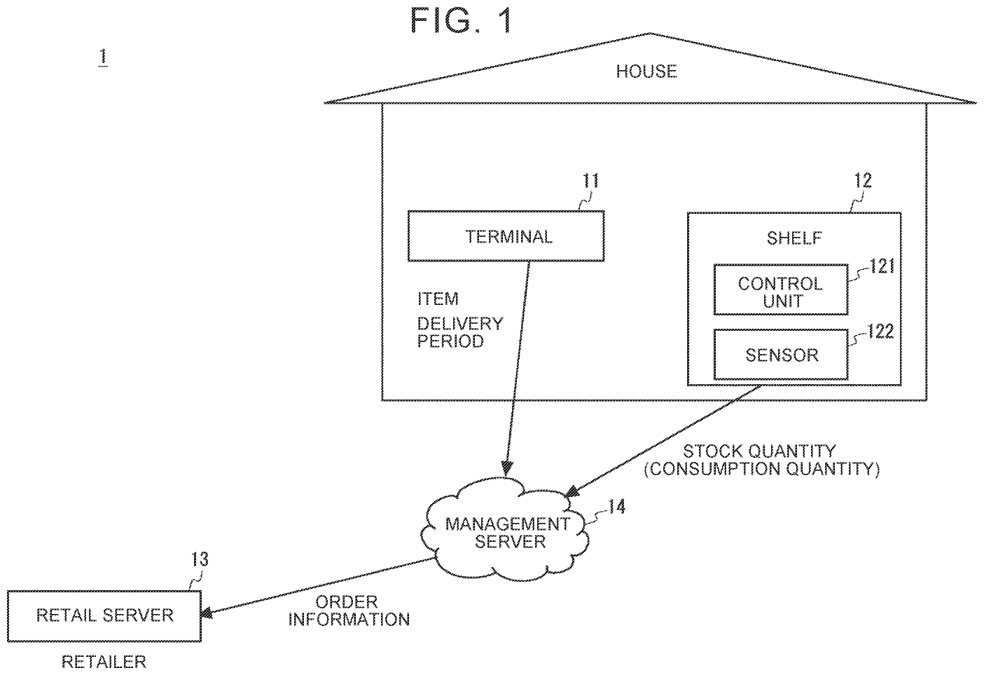

A management system according to the embodiment will be described below with reference to the drawings. FIG. 1 is a block diagram showing a configuration example of a management system 1 according to the embodiment. The management system 1 is a management system that manages the placement of an order for goods. In this specification, goods are consumed articles such as daily necessities and groceries. Goods are also called consumables. The management system 1 manages the stock of goods in the house. The management system 1 may automatically place an order according to the consumption of goods.

The management system 1 includes a terminal 11, a shelf 12, a retail server 13, and a management server 14. The shelf 12 includes a control unit 121 that performs various types of control. The processing performed by the management system 1 may also be performed by the shelf 12. That is, a system that does not include the management server 14 and that the processing is completed in the shelf 12 may also be included in the management system 1 according to the embodiment.

The terminal 11, control unit 121, retail server 13, and management server 14 each include an arithmetic unit, such as a central processing unit (CPU), and a storage unit such as a random access memory (RAM) and a read only memory (ROM). The storage unit stores various control programs and data. That is, the terminal 11, control unit 121, retail server 13, and management server 14, each of which has the function of a computer, perform the processing described below based on the above-mentioned various control programs.

The terminal 11 is a wired or wireless communication terminal connected to the management server 14 for communication therewith. The terminal 11 is not particularly limited as long as it can communicate with the management server 14. For example, the terminal 11 is a mobile communication terminal, such as a smartphone or a tablet terminal, or a personal computer (PC) installed indoors.

Although located in the living space of the house in FIG. 1, the terminal 11 may also be located in an outdoor space or in an indoor space other than the living space. In this specification, the house includes an apartment house, an office building, and the like, and the living space includes an office space.

The user enters a delivery period for each item of goods via the terminal 11. When ordering goods, the management system 1 places an order so that goods will be delivered in the delivery period. That is, the delivery period is a period during which the ordered goods are delivered. The management system 1 may also be a system that places an order for a predetermined quantity of goods, for example, when the stock quantity of goods decreases by a predetermined quantity. The management system 1 may also be a system that places an order for a predetermined quantity of goods when the stock quantity of goods becomes equal to or less than the threshold value. This threshold value, also referred to as the minimum stock quantity, may be set by the user. The management system 1 may also place an order either on a regular basis or according to a user's instruction. The entered information is sent from the terminal 11 to the management server 14.

For example, the user sets a minimum stock quantity for each piece of goods. After setting the minimum stock quantity, the user may roughly calculate a period until the minimum stock quantity of goods is used up and, then, set the calculated period as the delivery period. As described above, when the quantity of goods becomes less than the minimum stock quantity, the management system 1 can place an order for the goods. By placing an order in this way, the management system 1 can prevent goods from running out of stock. Alternatively, the user may roughly calculate the period until a predetermined quantity of goods described above is used up.

The shelf 12 houses articles including goods used in the house. In the description below, it is assumed that the shelf 12 houses multiple types of goods. The shelf 12 may also be installed outside the house. The quantity of housed goods is managed by the management server 14 that will be described later. The shelf 12 has a sensor 122. This sensor 122 measures the quantity of goods taken from the shelf 12 and the quantity of goods housed in the shelf 12. The sensor 122 may be a weight sensor or a camera. The control unit 121 of the shelf 12 sends the stock quantity, and the consumption quantity, of each piece of goods to the management server 14.

The retail server 13 is a server operated by a retailer. The retail server 13 is, for example, a server that constitutes an EC site, operated by an electronic commerce (EC) company, on the Internet. The retail server 13 is connected to the management server 14 for communication therewith and receives order information. The management system 1 may have a delivery robot that receives goods from a retailer and delivers them to the shelf 12. Of course, humans may deliver the goods. The management server 14, which will be described later, may also have the function to create a delivery plan in which an autonomous moving body or a human-driven vehicle is used.

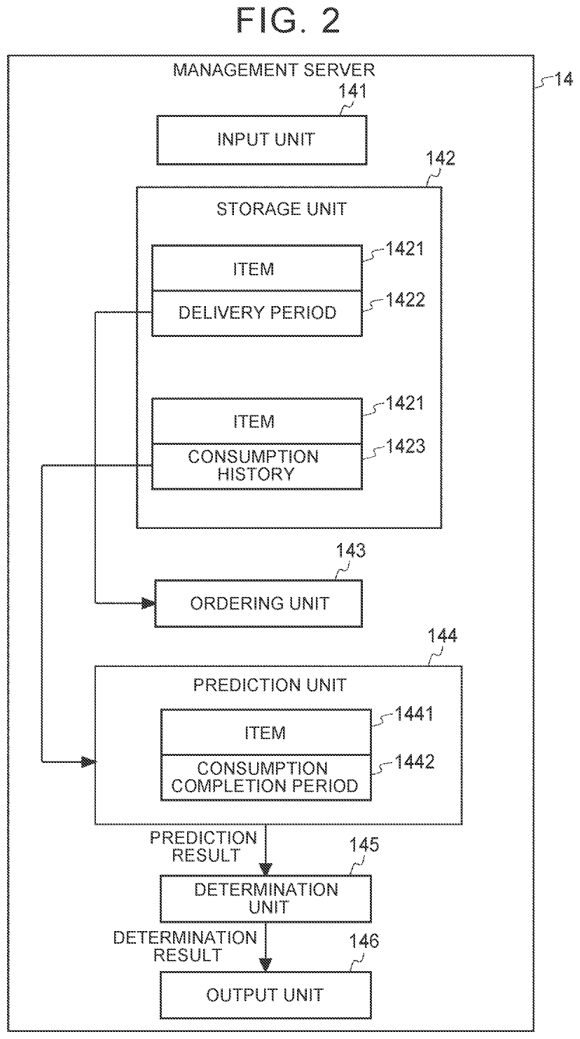

The management server 14 manages the placement of an order for goods housed on the shelf 12. The management server 14 places an order for goods, housed on the shelf 12, based on the delivery period that has been set. FIG. 2 is a block diagram showing the functional configuration of the management server 14. The management server 14 includes an input unit 141, a storage unit 142, an ordering unit 143, a prediction unit 144, a determination unit 145, and an output unit 146.

The input unit 141 registers an item 1421 of goods and the delivery period 1422 in the storage unit 142 in association with each other when they are entered from the user via terminal 11. The item 1421 is also referred to as a goods ID. As described above, the delivery period 1422 represents a period during which ordered goods should be delivered. A minimum stock quantity (not shown), which indicates the lower limit of the stock quantity, may further be registered in association with the item 1421.

The storage unit 142 stores the item 1421 of goods and the delivery period 1422 in association with each other. In addition, the storage unit 142 stores the item 1421 and the consumption history 1423 of goods in association with each other. The consumption history 1423 is generated based on the detection result of the sensor 122 included in the shelf 12. The consumption history 1423 may also be calculated based on a change in the stock quantity of each piece of goods. The consumption history 1423 may also be data indicating, for example, the weekly or daily consumption quantity of each piece of goods. The consumption history 1423 may also be calculated based on the number of times the shelf 12 is used (for example, the number of times the door is opened and closed).

The storage unit 142 may further store a prediction history (not shown). The prediction history is a history of prediction results generated by the prediction unit 144 that will be described later.

The ordering unit 143 manages the stock quantity of each piece of goods based on the detection result of the sensor 122 included in the shelf 12. The ordering unit 143 may automatically place an order for each piece of goods based on the minimum stock quantity (not shown) and the delivery period 1422. More specifically, when the stock quantity of goods becomes less than the minimum stock quantity (not shown), the ordering unit 143 may automatically place an order for the goods. The ordering unit 143 may also place an order for a predetermined quantity of goods when the stock quantity of goods decreases by a predetermined quantity.

When ordering goods, the ordering unit 143 places an order for goods so that the goods are delivered during the delivery period 1422. For example, when the delivery period 1422 is one week, the ordering unit 143 places an order so that the goods are delivered within one week. The ordering unit 143 may also place an order, for example, by specifying a delivery date. The ordering unit 143 may also place an order at an opportune time with consideration for the delivery date such that goods are delivered in the delivery period 1422.

As described above, the user may roughly calculate a period until a predetermined quantity (for example, minimum stock quantity) of goods is used up and then set the calculated period as the delivery period 1422. Therefore, as long as the consumption rate of goods does not change, the management system 1 can keep the stock quantity of goods, housed on the shelf 12, within a certain range of stock.

The prediction unit 144 predicts a consumption completion period 1442 for each item 1441 based on the consumption history 1423. The item 1441 corresponds to the item 1421 described above. The consumption completion period 1442 is a period from the start to the completion of consumption of a predetermined quantity (for example, minimum stock quantity) of goods. For example, when the minimum stock quantity of masks (not shown) is set to one box, the prediction unit 144 may calculate the period required to consume one box of masks as the consumption completion period 1442. The prediction unit 144 may also calculate the consumption rate of goods based on the consumption history 1423 and, based on the calculated consumption rate, predict the consumption completion period 1442. The prediction unit 144 may also predict the period until the goods stored in the shelf 12 are used up, or the period until the predetermined delivery unit of the goods is used up, as the consumption completion period 1442.

The prediction unit 144 may predict the consumption completion period 1442 of each item 1441 every predetermined period, that is, regularly. For example, the prediction unit 144 may predict the consumption completion period 1442 on a weekly basis or on a daily basis. The prediction unit 144 may also predict the consumption completion period 1442 each time the stock quantity is acquired from the sensor 122. The prediction unit 144 outputs the prediction result to the determination unit 145.

The prediction unit 144 may acquire the consumption history 1423 of goods in a house different from the house in which the management system 1 manages the placement of an order and, further based on the acquired result, predict the consumption completion period 1442. The prediction unit 144 can improve the prediction accuracy by learning the consumption tendency in a plurality of houses in this way.

The determination unit 145 determines whether the delivery period 1422 needs to be changed, based on the prediction result of the prediction unit 144. To do so, the determination unit 145 may compare the consumption completion period of goods in a past predetermined period (for example, several months) with the consumption completion period 1442 predicted by the prediction unit 144 and, based on the result of the comparison, determine whether the delivery period 1422 needs to be changed. For example, the determination unit 145 may calculate the difference between the average value of the consumption completion periods in a past predetermined period and the consumption completion period 1442 and, when the difference exceeds the threshold value, determine that the delivery period 1422 needs to be changed. The consumption completion periods of goods in the past predetermined period may be acquired from the storage unit 142.

The determination unit 145 may also compare the consumption completion period in a past predetermined period (for example: several months) with the consumption completion period in the most recent predetermined period (for example: several weeks) and, based on the result of the comparison, determine whether the delivery period 1422 needs to be changed. The consumption completion period in the most recent predetermined period includes the prediction result (consumption completion period 1442) predicted by the prediction unit 144. More specifically, when the prediction unit 144 predicts the consumption completion period on a daily basis and when each of the consumption completion periods in the most recent one week is different from the average value of the consumption completion periods in the past several months, the determination unit 145 may determine that the delivery period 1422 needs to be changed. In such a case, the determination unit 145 can determine that the delivery period 1422 needs to be changed when the change in the consumption rate has continued for a certain period of time.

The determination unit 145 may determine whether the delivery period 1422 needs to be changed based on a past prediction result predicted by the prediction unit 144 and a new prediction result predicted by the prediction unit 144. For example, the determination unit 145 may compare the prediction value (prediction result) in a past predetermined period with the prediction value in the most recent predetermined period and, based on the result of the comparison, determine whether the delivery period needs to be changed. The prediction value in the most recent predetermined period includes the new prediction value. The determination unit 145 may also compare the prediction value in the past predetermined period with the new prediction value and, based on the result of the comparison, determine whether the delivery period 1422 needs to be changed.

The determination unit 145 may also calculate the difference between the predicted consumption completion period 1442 and the set delivery period 1422 and, when the difference is equal to or greater than the threshold value, determine that the delivery period 1422 needs to be changed.

The output unit 146 generates a message prompting the user to change the setting of the delivery period 1422 and outputs the generated message to the terminal 11 when the determination unit 145 determines that the delivery period 1422 needs to be changed. The user who confirms the message can set a new delivery period 1422. In this case, the management server 14 may also calculate an appropriate delivery period and recommend the calculated delivery period to the user. When it is determined that the delivery period 1422 needs to be changed, the management server 14 may set the appropriate delivery period 1422.

The management system according to the embodiment predicts the period until goods are used up based on the consumption history and, based on the prediction, determines whether the delivery period is appropriate. Therefore, when the consumption rate changes, the management system according to the embodiment can prompt the user to change the setting of the delivery period. For example, in the season of hay fever, the management system according to the embodiment helps the user to set a shorter delivery period for masks and tissues.

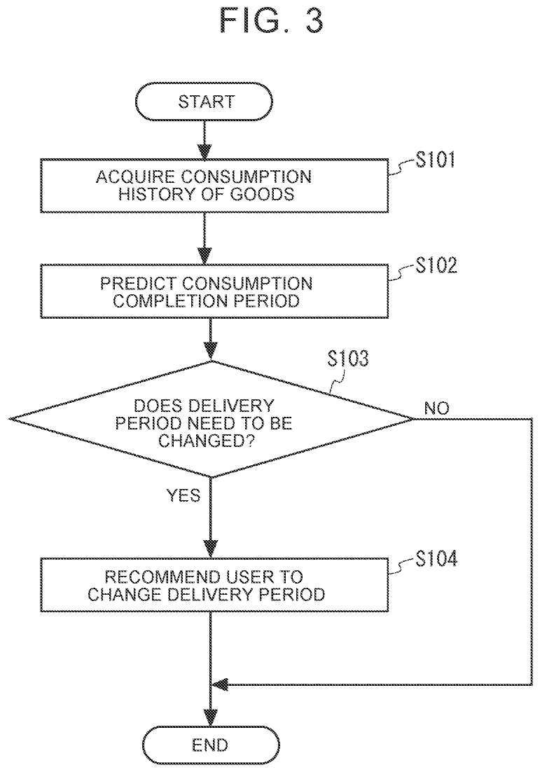

FIG. 3 is a flowchart showing an example of the flow of the management method according to the embodiment. It is assumed that the delivery period 1422 has been set for each piece of goods based on a user input.

First, the prediction unit 144 acquires the consumption history 1423 of the goods housed in the shelf 12 (step S101). Next, the prediction unit 144 calculates the consumption completion period 1442, which is the period until a predetermined quantity of goods (for example, the minimum stock quantity) is used up, based on the consumption history 1423 (step S102).

Next, the determination unit 145 determines whether the delivery period 1422 needs to be changed (step S103). For example, the determination unit 145 may compare the consumption completion period 1442, calculated in step S102, with the past prediction result predicted by the prediction unit 144 and, based on the result of the comparison, determine whether the consumption completion period 1442 has changed. The determination unit 145 may also acquire the period, required to actually use up the predetermined quantity of goods, from the consumption history 1423 and compare the acquired period with the prediction result calculated in step S102.

When the delivery period 1422 does not need to be changed (No in step S103), the management server 14 ends the processing. On the other hand, when the delivery period needs to be changed (Yes in step S103), the output unit 146 of the management server 14 outputs a message to the terminal 11 to prompt the user to change the delivery period 1422 (step S104).

The effects of the embodiment will be described below. The management system according to the embodiment predicts the consumption completion period based on the consumption history and, based on the prediction result, determines whether the delivery period needs to be changed. Therefore, the management system according to the embodiment can help the user to set an appropriate delivery period.

In addition, even when goods are purchased in bulk, the management server according to the embodiment can accurately predict the consumption completion period of goods in the house based on the detection result of the sensor. In addition, since the delivery period is set for each item of goods, the management server according to the embodiment can recommend a person different for each product to change the delivery period. For example, by distinguishing beer by brand, a recommendation may be made to the father or mother according to the brand.

In the above example, various types of control programs are stored using various types of non-transitory computer readable media for supplying programs to a computer. Non-transitory computer-readable media include various types of tangible storage media. Examples of non-transitory computer-readable media include magnetic recording media (for example, flexible disks, magnetic tapes, hard disk drives), magneto-optical recording media (for example, magneto-optical disks), CD-ROMs, CD-Rs, CD-R/Ws, semiconductor memories (for example, mask ROM, programmable ROM (PROM), erasable PROM (EPROM), flash ROM, RAM). Programs may also be supplied to a computer using various types of transitory computer readable media. Examples of transitory computer-readable media include electrical signals, optical signals, and electromagnetic waves. Transitory computer-readable media can be used to supply programs to a computer via a wired communication path, such as an electric wire and an optical fiber, or a wireless communication path.

An applicable embodiment of the present disclosure is not limited to the above embodiment, and can be appropriately changed without departing from the spirit.

What is claimed is:

1. A management system that places an order for consumed goods based on a delivery period, the management system comprising:
a prediction unit configured to predict a consumption completion period based on a consumption history of the goods, the consumption completion period being a period from a start to a completion of consumption of a predetermined quantity of the goods; and
a determination unit configured to determine whether the delivery period needs to be changed based on a prediction result predicted by the prediction unit.

2. The management system according to claim 1, wherein:
the delivery period and a minimum stock quantity are set for the goods;
the prediction unit is configured to predict the consumption completion period based on the consumption history, the consumption completion period being a period from a start to a completion of consumption of the minimum stock quantity of the goods; and
the management system further includes an ordering unit configured to place an order for the goods so that the goods are delivered in the delivery period when a stock quantity of the goods becomes less than the minimum stock quantity.

3. The management system according to claim 1, wherein the determination unit is configured to compare the consumption completion period in a past predetermined period with the consumption completion period predicted by the prediction unit and, based on a result of the comparison, to determine whether the delivery period needs to be changed.

4. The management system according to claim 1, wherein the determination unit is configured to compare the consumption completion period in a past predetermined period with the consumption completion period in a most recent predetermined period and, based on a result of the comparison, to determine whether the delivery period needs to be changed.

5. The management system according to claim 1, wherein the determination unit is configured to determine whether the delivery period needs to be changed based on a past prediction result predicted by the prediction unit and a new prediction result predicted by the prediction unit.

6. The management system according to claim 1, wherein:
the delivery period is able to be set by a user; and
the management system further includes an output unit configured to output a message when the determination unit determines that the delivery period needs to be changed, the message prompting the user to change a setting of the delivery period.

7. The management system according to claim 1, wherein the prediction unit is configured to calculate a consumption rate of the goods based on the consumption history and to predict the consumption completion period based on the consumption rate.

8. The management system according to claim 1, wherein the prediction unit is configured to acquire a consumption history of the goods in a house different from a house in which the management system manages a placement of an order and to predict the consumption completion period further based on an acquisition result.

9. A management method for placing an order for consumed goods based on a delivery period, the management method performed by a computer and comprising:
predicting a consumption completion period based on a consumption history of the goods, the consumption completion period being a period from a start to a completion of consumption of a predetermined quantity of the goods; and
determining whether the delivery period needs to be changed based on a prediction result predicted by the predicting.

10. A management program that places an order for consumed goods based on a delivery period, the management program causing a computer to perform:
predicting a consumption completion period based on a consumption history of the goods, the consumption completion period being a period from a start to a completion of consumption of a predetermined quantity of the goods; and
determining whether the delivery period needs to be changed based on a prediction result predicted by the predicting.
